(19) United States
(12) Patent Application Publication
(10) Pub. No.: US 2006/0015062 A1
(43) Pub. Date: Jan. 19, 2006

(54) Disposable mouthwash container

(76) Inventor: Soleyman Kahen, Los Angeles, CA (US)

Correspondence Address: BIRCH STEWART KOLASCH & BIRCH, PO BOX 747, FALLS CHURCH, VA, 22040-0747, US

(21) Appl. No.: 11/084,744

(22) Filed: Mar. 18, 2005

Related U.S. Application Data
(60) Provisional application No. 60/554,874, filed on Mar. 19, 2004.

(51) Int. Cl. A61J 7/00

(52) U.S. Cl. 604/77

(57) ABSTRACT

A disposable mouthwash container for use at a remote location such as a restaurant or preparatory to a meeting, for quick and easy rinsing of the user's mouth and to receive the used mouthwash back into the same container and be re-sealed for disposal. Each embodiment of the invention seals the mouthwash liquid in a reservoir in the container and has an easily openable top providing access to the mouthwash, and a return spout for directing the used mouthwash back into the container, which is reclosed for disposal. A quick-release key ring connection is provided for mounting the container on a key ring for ready availability, and a reflective tape mirror is provided on some embodiments to facilitate inspection after use.

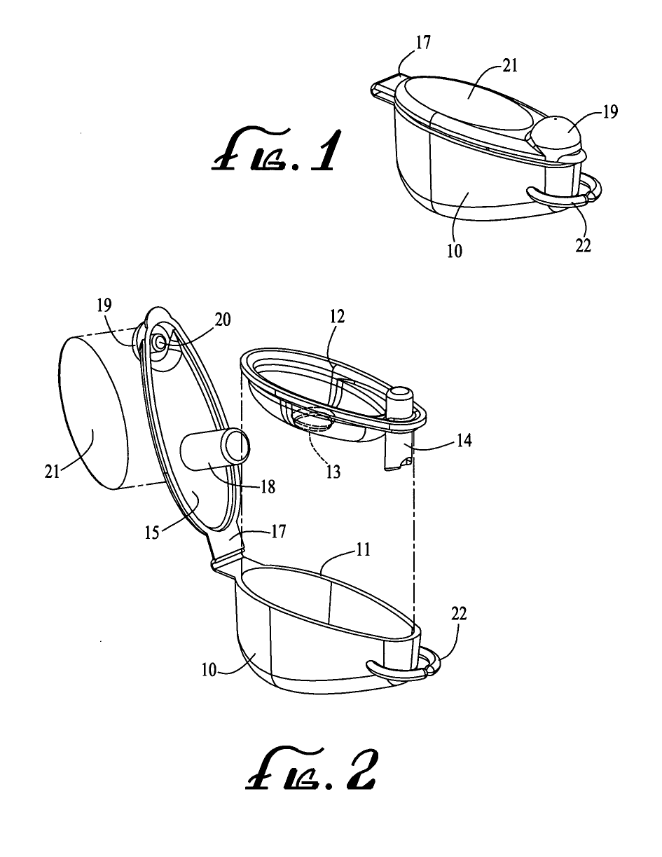

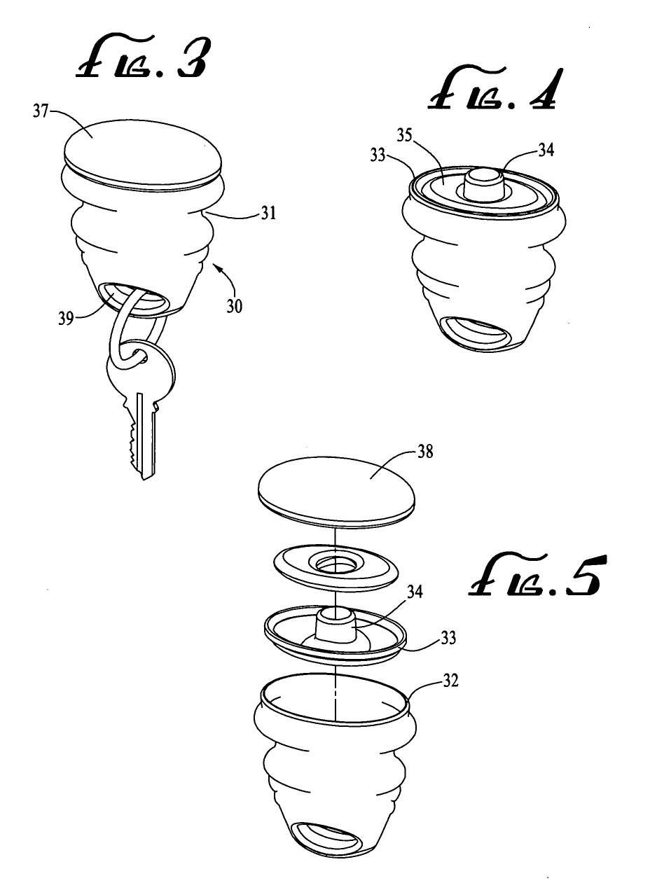

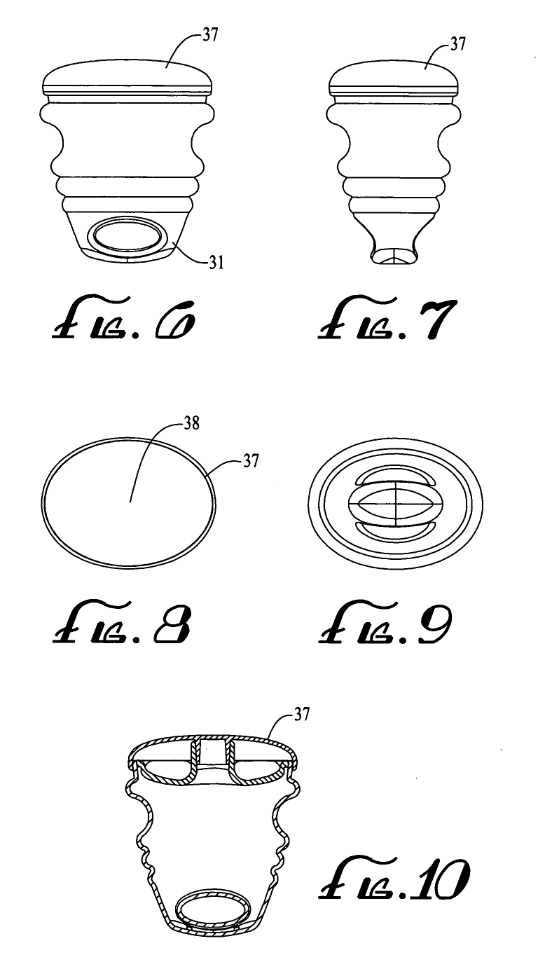

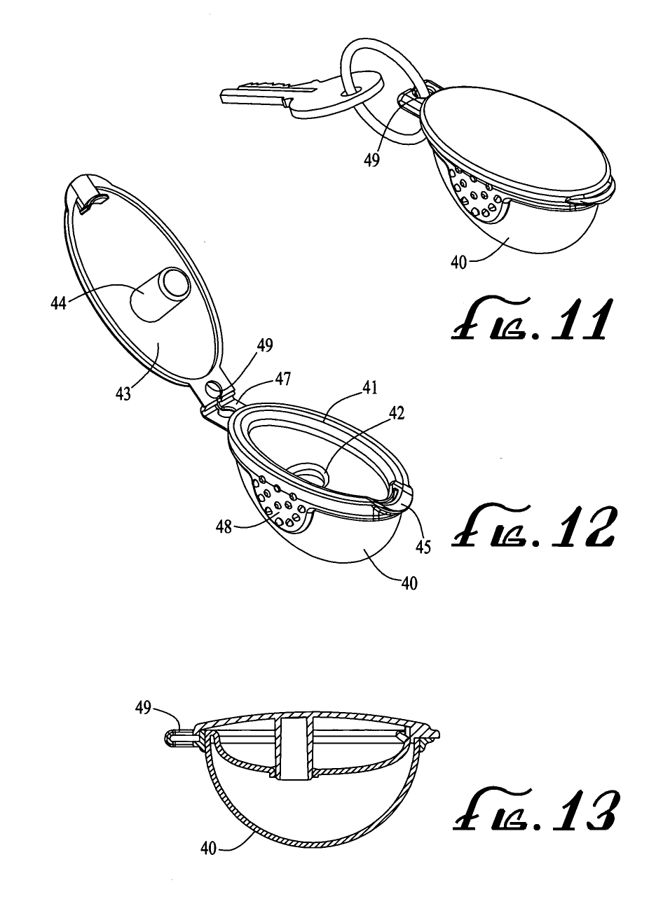

### CROSS-REFERENCE TO RELATED APPLICATION

This Non-provisional application claims priority under 35 U.S.C. § 119(e) on U.S. Provisional Application No(s). 60/554,874 filed on Mar. 19, 2004, the entire contents of which are hereby incorporated by reference.

### BACKGROUND OF THE INVENTION

This invention relates to a disposable mouthwash container adapted to be carried by a user and available for use in locations remote from the user's home, such as after a meal at a restaurant or preparatory to a meeting to freshen the mouth and breath, typically with a sufficient amount of liquid for a single treatment.

Disposable containers have been known for this purpose, including the one shown in U.S. Pat. No. 6,258,057, wherein an elongated packet comprises a receptacle member having a mouthwash supply chamber at one end and a larger recovery chamber at the other, with membrane members and puncturing elements and relatively bulky and complex construction.

### SUMMARY OF THE INVENTION

The present invention resides in a small and more easily portable mouthwash container that is very simple and inexpensive in construction and easy to use, typically with one hand, that dispenses the stored mouthwash neatly and easily into the user's mouth and receives the used mouthwash back into the container, also neatly and easily. The invention is embodied in several different forms that are shown herein for purposes of illustration.

### BRIEF DESCRIPTION OF THE DRAWINGS AND DETAILED DESCRIPTION

Sheet 1 of the drawings illustrates a first embodiment of the invention in which a quantity of mouthwash liquid can be stored in a small, tub-like elongated container 10 having an open top 11 and a tub-like sink insert 12 forming a false bottom spaced above the bottom of the tub. The insert is formed with a drain hole 13 in the center and carries a hollow straw 14 at one end, passing through the insert and opening into the lower portion of the tub. The container has a generally flat, elongated cover 15 that is joined to the tub by an integral hinge 17 and carries a central plug 18 for closing the hole in the insert, and has a mouthpiece 19 at the free end, with a removable plug 20 for fitting into the straw 14. The cover seals against the tub when closed, and opens to provide access to the straw, through which the user takes in the liquid, preferably tipping the container toward the straw 14. After rinsing the mouth, the user spits the liquid back into the sink insert. The elongated open top 11 is sized and shaped to fit around the mouth, in a general “lip shape,” and the drain hole 13 permits the excess to pass from the sink into the tub. The cover is reclosable for disposal of the used mouthwash. A reflective tape 21 on the outside of the cover forms a mirror for inspection of the mouth area after use, and a split ring 22 on one end forms a quick-release key ring for mounting the container on an automobile key or the like, for ready availability.

Sheets 2 and 3 of the drawings show alternative forms of a second embodiment of the invention, using a bellows-shaped container 30 composed of flexible plastic and having a central gripping groove 31 and an open top 32. The top is fitted with a dished annular mouthpiece 33, having an upstanding spout 34. Fitted in the mouthpiece around the spout is a ring of absorbent material 35, and a circular cover 37 fits over the open end and seals against the container, which holds a quantity of mouthwash liquid. An upstanding hollow sleeve 38 on the cover 37 in Sheet 1 fits over the spout and has a top wall that seals the spout until the cover is removed, and the cover 37 in Sheet 3 has a flat top that serves the same function. The central bellows portion of both forms of this embodiment is expandable, by pulling the lower end downwardly away from the top, to draw the used mouthwash back through the spout into the container after use, and to provide extra capacity for saliva. A key ring attachment 39 is formed on the bottom of the container, and serves as a grip for expanding the bellows. The absorbent material 35 neatly receives any leakage around the spout, and the cover is reclosable, as in the other embodiments.

Sheets 4 shows another embodiment of the invention in which a container in the form of a rubber bulb or tub 40 of somewhat flattened circular cross-sectional shape is fitted with a sink insert 41, as in Sheet 1, having a drain hole 42 overlying a reservoir in the tub, and a one-piece cover or lid 43, with a depending sleeve 44 that seals the sink hole, when the lid is closed, retaining the mouthwash in the compartment defined between the sink and the cover. When the cover is lifted, the liquid is taken into the mouth over a mouthpiece spout 45 (and an aligned slot from the reservoir under the insert, by tipping the open container toward the user. The cover is hingedly mounted on an integral strap 47 that forms the mouthpiece spout 45 and also carries two squeeze-pads 48 on opposite sides of the flexible container. To facilitate release of the mouthwash, these pads are squeezed together, and to facilitate the return of the mouthwash, they are released so that the resilience of the container will expand the container and draw the mouthwash into the reservoir. The cover is reclosable for disposal of the used mouthwash. A quick-release key ring connector 49 is formed in the hinge strap at one end of the cover.

Sheets 5 through 9 show additional variations of the invention utilizing the same principles, Sheets 5 and 6 showing a one-piece plastic construction; Sheet 7 showing a variation of the form in Sheets 3 and 4; and the remaining sheets showing other forms.

I claim as my invention:

1. A disposable mouthwash container for holding and dispensing a body of liquid mouthwash and receiving the mouthwash for disposal after use, comprising:
a tub-like container having an open side and defining a reservoir for the mouthwash;
a dished sink fitted in said open side over said reservoir and forming an internal top wall for the reservoir, said sink having an passage permitting flow of mouthwash therethrough;
and a movable cover for said tub-like container overlying said sink and normally releasably closing said open side, said cover having means thereon for closing said passage in said sink when the cover is in a closed position against the open side and for opening said passage when the cover is in an open position spaced from said open side.

2. A mouthwash container as defined in claim 1 wherein said sink has a central drain hole forming said passage, and has a second passage formed by a hollow straw passing through the sink and opening into the reservoir, said cover having a central plug closing the drain hole when the cover is closed and a mouthpiece, and a plug for fitting into said straw.

3. A mouthwash container as defined in claim 2 wherein the container and the sink are elongated and shaped to fit around the mouth for return of the used mouthwash to the reservoir through the sink.

4. A mouthwash container as defined in claim 1 wherein the tub-like container is bellows-shaped and comprised of flexible material permitting contraction of the container during dispensing of the mouthwash and contraction of the container during return of the mouthwash to the container.

5. A mouthwash container as defined in claim 4 wherein said dished sink is a shallow mouthpiece and said passage is defined by an upstanding spout, and said cover has a wall closing said spout when the cover is in the closed position.

6. A mouthwash container as defined in claim 6 further including an absorbent ring around said upstanding spout.

7. A mouthwash container as defined in claim 1 wherein the tub-like container is in the form of a flexible bulb of flattened circular cross-sectional shape, and said cover has a depending member that closes and seals the passage through said sink when the cover is closed, said sink and said container defining a mouthpiece spout on one side for dispensing the liquid.

8. A mouthwash container as defined in claim 7 wherein said rubber bulb has squeeze pads on the flattened sides thereof.

9. A mouthwash container as defined in claim 1 further including a strip of reflective material on said cover forming a mirror.

10. A mouthwash container as defined in claim 1 further including a connector on said container for coupling the container to a key ring.
